(19) United States
(12) Patent Application Publication
(10) Pub. No.: US 2003/0204543 A1
(43) Pub. Date: Oct. 30, 2003

(54) Device and method for estimating harmonics in voice encoder

(75) Inventors: Sung Wan Yoon, Seoul (KR); Yong Soo Choi, Gwanginyeong-si (KR); Dae Hee Youn, Seoul (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/425,743

(22) Filed: Apr. 30, 2003

(30) Foreign Application Priority Data
Apr. 30, 2002 (KR) 23751/2002

(51) Int. Cl. G06F 17/10

(52) U.S. Cl. 708/300

(57) ABSTRACT

The present invention relates to methods and devices for estimating harmonics that reduce the calculation amount and can be used very effectively in a low transmission rate voice encoder by adjusting a harmonic interval with centering on a multiple of a basic frequency or extracting a peak so that the error between an original signal spectrum and estimated harmonic spectrum is reduced.

### BACKGROUND OF THE INVENTION

1. Field of the Invention

The present invention relates to a device and a method for estimating harmonics in a voice encoder.

2. Description of the Related Art

As information communication technology is developed rapidly, a voice processing is used as an important means for communication. Voice process is separated roughly into voice encoding, voice recognition and voice transformation. The voice encoding is one of outstanding technologies in recent multimedia environment.

Owing to this development of multimedia and mobile communication, the services once only provided to special groups or people can be provided to the general public now and the number of the services has increased by geometric progression. Therefore, transmission rate used till now cannot satisfy user groups. If the transmission rate is decreased and the number of the users is increased, voice quality degenerates. In this environment, the voice encoders are developed.

In the voice communication service using mobile communication networks and data networks that has been generalized now, different voice encoders are used according to objects and application. A voice encoder receives a human voice by a microphone, transforms frequency distribution, intensity and waveform of the corresponding voice data into a code, transmits the code and synthesizes the code. The voice encoder is employed in mobile communication terminals, telephone exchanges, video conference systems and the like.

Most of the low transmission rate voice encoders used in multimedia communication and voice storage systems such as Voice over IP (VoIP) are code-excited linear prediction (CELP) encoders. There are CELP encoders that are time domain encoders for the transmission rate of 4 to 13 Kbps and frequency domain encoders for the transmission rate of 4 Kbps or less.

A harmonic encoder represents an excited signal in harmonic components of a basic frequency. Accordingly, the synthesized voice of the harmonic encoder is less natural in the voiceless sound interval than those of CELP encoder that represents an excited signal in the form of white noise.

However, the harmonic encoder can encode the voice signal at lower bit rate than the CELP encoder in the voiced sound interval that occupies most of the voice signal. The harmonic encoder is used as a voice encoder that has a transmission rate of 4 Kbps or less.

### SUMMARY OF THE INVENTION

Accordingly, the present invention is directed to a device and a method for estimating harmonics in a voice encoder. In one embodiment, the present invention provides a device and a method for estimating harmonics in a voice encoder that reduce calculation amount using a delta adjustment technology. Additionally, the present invention provides a device and a method for estimating harmonics in a voice encoder that reduce calculation using a peak extracting and a delta adjustment technology. Further, the present invention provides a device and a method for estimating harmonics in a voice encoder that are very efficient in a real time implementation in which a digital signal processor (DSP) is used. Still further, the present invention provides a device and a method for estimating harmonics in a voice encoder that substitute for conventional technology by providing the necessary technology in low transmission rate voice encoder.

Accordingly, an embodiment of the invention provides a harmonic estimating method for a voice encoder comprising: applying window spectrum to an input signal, performing fast Fourier transformation of amplitude of N1 on a generated spectrum, and calculating an input signal spectrum; applying window spectrum scaled by harmonic amplitude to an integer pitch candidate, performing fast Fourier transformation of amplitude of N2 on a generated spectrum, and calculating an synthesized signal spectrum; calculating an adjustment value of a high frequency at which error energy of the found input signal spectrum and the synthesized signal spectrum for each band is minimized in range of the adjustment value of a harmonic frequency using the integer unit pitch; and calculating maximum harmonic amplitude by using the adjustment value of the high frequency at which the found error energy for each band is minimized.

In another embodiment of the present invention, a harmonic estimating device of a voice encoder comprises: a harmonic frequency adjusting means for calculating a range of a harmonic frequency adjustment value using an integer unit pitch, and selecting a frequency adjustment value at which error energy is minimized by using the harmonic frequency adjustment value belonging to the range; and a harmonic amplitude estimating means for estimating a maximum harmonic amplitude by harmonics using the harmonic frequency adjustment value at which the error energy is minimized, the harmonic frequency adjustment value being found by the harmonic frequency adjusting means.

In yet another embodiment of the present invention, a harmonic estimating device of a voice encoder comprises: a means for calculating an input signal spectrum of an input signal, applying window spectrum to an integer pitch candidate, and a synthesized signal spectrum; a means for extracting a peak point from each harmonic band, and calculating a limit value of frequency adjustment of each harmonic band; a means for calculating error energy of the found input signal spectrum and the found synthesized signal spectrum for each band by using the found limit value of frequency adjustment and the found peak point; a means for calculating a harmonic frequency adjustment value at which the error energy is minimized and a peak point; and a means for calculating a harmonic amplitude using the found harmonic frequency adjustment value and a peak point.

It is to be understood that both the foregoing general description and the following detailed description of the present invention are exemplary and explanatory and are intended only to provide further explanation of the invention without limitation to the invention as claimed.

### BRIEF DESCRIPTION OF THE DRAWINGS

The accompanying drawings illustrate embodiment(s) of the invention and together with the description serve to describe the invention. In the drawings:

FIG. 1 is a block diagram illustrating a harmonic estimating method based on fractional pitch according to a first embodiment of the present invention;

FIG. 2 is a flowchart illustrating a harmonic estimating method based on fractional pitch according to a first embodiment of the present invention;

FIG. 3 is a block diagram illustrating a harmonic estimating device using a delta adjusting method according to a second embodiment of the present invention;

FIG. 4 is a flowchart illustrating a harmonic estimating method using a delta adjusting method according to a second embodiment of the present invention;

FIG. 5 is schematic view illustrating a harmonic estimating device using a delta adjusting method and peak extracting according to a third embodiment of the present invention;

FIG. 6 is detailed view illustrating a harmonic estimating device using a delta adjusting method and peak extracting according to a third embodiment of the present invention;

FIG. 7 is a flowchart illustrating a harmonic estimating method using a delta adjusting method and a peak extracting method according to a third embodiment of the present invention;

FIG. 8 illustrates a synthesized signal spectrum in the case using only a delta adjusting method; and

FIG. 9 illustrates a synthesized signal spectrum in the case using a delta adjusting method and a peak extracting method according to an embodiment of the present invention.

### DETAILED DESCRIPTION OF THE INVENTION

Reference will now be made to embodiments of the present invention, examples of which are illustrated in the accompanying drawings. A device and a method for estimating harmonics in a voice encoder according to the present invention will be described in the following description.

A harmonic encoder includes a harmonic estimating device and a harmonic synthesizer. The harmonic estimating device should be designed considering the performance and calculation capacity of the system. The spectrum harmonic estimation affects the calculation amount and sound quality.

In addition, the harmonic estimating device demands a lot of calculation amount of pitches, amplitudes, phases and the like and can use a digital signal processor (DSP). The pitch is searched for with an integer unit in time domain and with a fractional unit in frequency domain. The harmonic estimating method based on fractional pitch requires a large amount of calculation since the harmonic estimating method is performed by analysis using synthesis in which the error energy of an input signal spectrum and a synthesized signal spectrum is minimized.

On the other hand, a pitch envelope is more important to sound quality than a pitch resolution in the harmonic encoder to replay the synthesized signal by interpolation, contrary to a CELP encoder. Harmonic estimating methods include discrete Fourier transformation (DFT) and fast Fourier transformation (FFT). If the harmonic estimating method based on discrete Fourier transformation is used, the amplitude and the phase of spectrum harmonics can be estimated at once without any relation to pitch period. When the pitch period is large, a large amount of calculation is required in discrete Fourier transformation.

In the harmonic estimating method based on fast Fourier transformation, a peak peaking method of performing FFT on two or three pitch period waves and extracting the highest point of the spectrum to observe harmonics in spectrum, or a comparatively simple method such as a method of sampling a spectrum at the frequency corresponding to harmonics of a basic frequency can be used. As another method, there is a minimum mean squared error (MMSE) method that requires more calculation amount than the above-mentioned method and has higher performance.

A DFT based method is used for a pitch period unit harmonic encoder such as prototype-waveform interpolation (PWI). The FFT based method that has advantages in the calculation amount and is used for most of the other methods such as sinusoidal transform coder (STC), improved multi-band excitation (IMBE), and harmonic vector excitation coding (HVXC). For FFT based harmonic estimation, there is a MMSE method of performing FFT on two or more pitch period waveforms to calculate original spectrum X_{W}(m) and a synthesized signal spectrum X′_{W}(m, ω₀) and calculating the harmonic amplitude Aₗ at which error energy Eₗ of the found original spectrum X_{W} and the found synthesized signal spectrum X′_{W}(m, ω₀) is minimized.

The MMSE method includes the steps of applying window spectrum W_{R}(n) to an input signal x(n), calculating an input signal spectrum X_{W}(m) that is transformed by FFT with amplitude of N1, applying window spectrum W_{R}(n) to a fractional pitch candidate, calculating an synthesized signal spectrum X′_{W}(m, ω₀) that is transformed by FFT with amplitude of N2, and calculating l-th harmonic amplitude Δₗ(ω₀) of the voice data at which the error energy Eₗ(ω₀) of the input signal spectrum X_{W}(m) and the synthesized signal spectrum X′_{W}(m, ω₀) is minimized.

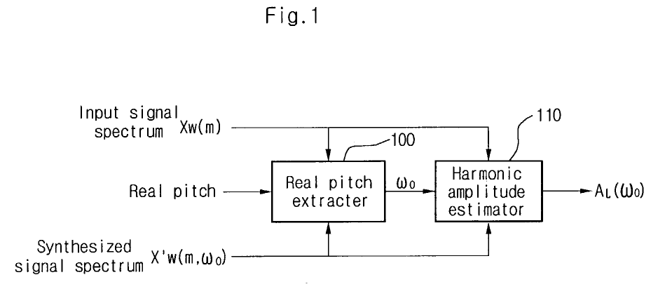

Now harmonic estimating method based on fractional pitch will be described in detail. FIG. 1 is a block diagram illustrating a harmonic estimating method based on fractional pitch according to a first embodiment of the present invention.

Referring to FIG. 1, fractional pitch extractor 100 calculates error energy Eₗ(ω₀) of the input signal spectrum X_{W}(m) and the synthesized signal spectrum X′_{W}(m, ω₀). In other words, the fractional pitch extractor 100 calculates the synthesized spectrum X′_{W}(m, ω₀) for the one input signal spectrum X_{W}(m) for m fractional pitch candidates, searches for the optimal fractional pitch candidate at which the error energy E(ω₀) that is sum of fractional pitch errors is minimized, and selects pitch basic frequency ω₀.

Here, the input signal spectrum X_{W}(m) is a signal obtained by performing FFT with amplitude of N1 on a signal X_{W}(n) that is obtained by multiplying window spectrum W_{R}(n) to the input signal X(n). The synthesized signal spectrum X′_{W}(m, ω₀) is a signal obtained by performing FFT with amplitude of N2 on the fractional pitch candidate using stored window spectrum W_{R}(m) with amplitude of N2. A harmonic amplitude estimator 110 selects the value at which the harmonic amplitude is maximized as an optimal harmonic using the frequency ω₀ at which the error energy found by the fractional pitch extractor 100 is minimized.

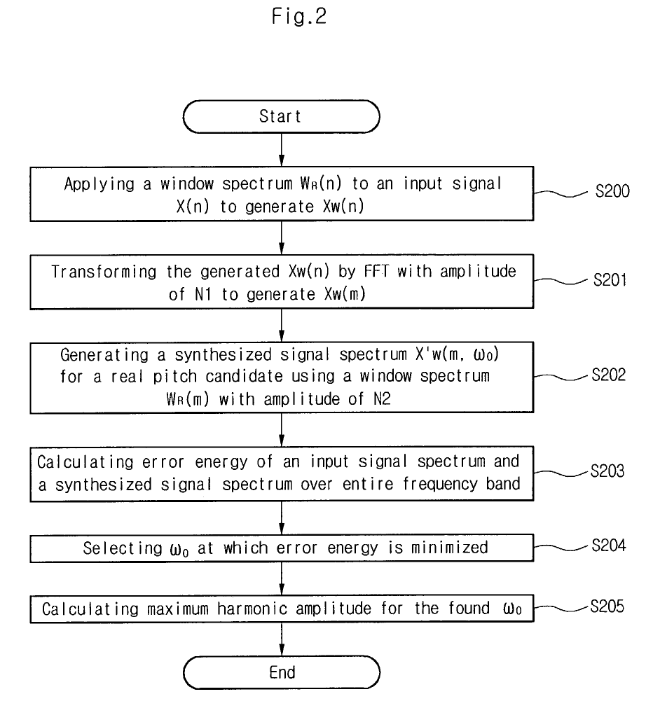

FIG. 2 is a flowchart illustrating a harmonic estimating method based on fractional pitch according to a first embodiment of the present invention. Referring to FIG. 2, the signal x_{W}(n) obtained by multiplying window spectrum w_{R}(n) to an input signal x(n) is generated (S200). The generated signal x_{W}(n) is transformed by FFT with amplitude of N1 and an input signal spectrum X_{W}(m) is generated (S201). The generated input signal spectrum X_{W}(m) is used as an input of a harmonic estimating device. The m can be greater than or equal to 0 and less than or equal to N1.

The synthesized signal spectrum X′_{W}(m, ω₀) for fractional pitch candidate is generated using window spectrum W_{R}(m) with amplitude of N2 (S202). Expression 1 calculates such a synthesized signal spectrum X′_{W}(m, ω₀) is as follows:

$$Expression 1 : \\ {X}_{W}^{′} ( m , {ω}_{0} ) = {A}_{i} ( {ω}_{0} ) \vert {W}_{R} [ \frac{N2}{N1} m - \frac{N2}{2 π} {ω}_{0} l + 0.5 ] \vert .$$

In Expression 1, Aₗ(ω₀) is harmonic amplitude. Expression 1 represents the synthesized signal spectrum X′_{W}(m, ω₀) in terms of window spectrum W_{R}(m, ω₀) scaled with harmonic amplitude Aₗ(ω₀). Here, N1≅2⁷, 2⁸, 2⁹. N2≅2¹², 2¹³, 2¹⁴.

Window spectrum W_{R}(m) is FFT spectrum of analysis window W_{R}(n) with amplitude of N2 (>>N1). The analysis window W_{R}(n) has the length of N_{R} so that two or more pitch periods Po are included. The operator [x] represents calculation that takes an integer part of the real number x.

The synthesized signal spectrum X′_{W}(m, ω₀) is found using start aₗ and end bₗ of l-th harmonic band. In general, Hamming window or Kaiser window is used as an analysis window W_{R}(n). In Expression 2, aₗ and bₗ are expressed as follows.

$$Expression 2 : \\ \begin{matrix}{a}_{i} = [ \frac{N1}{2 π} ( l - 0.5 ) {ω}_{0} + 0.5 ] \\ {b}_{i} = [ \frac{N1}{2 π} ( l + 0.5 ) {ω}_{0} + 0.5 ]\end{matrix}$$

If the synthesized signal spectrum is found (S202), error energy Eₗ(ω₀) of the input signal spectrum and the synthesized signal spectrum is found over entire frequency band (S203). This is obtained using Expression 3.

$$Expression 3 : \\ \begin{matrix}{E}_{i} ( {ω}_{0} ) = {\sum }_{m = {a}_{i}}^{{b}_{i}} {\{ \vert {X}_{W} ( m ) \vert - \vert {X}_{W}^{′} ( m , {ω}_{0} ) \vert \}}^{2} \\ where 1 \leq l \leq L , L = ⌊ \frac{π}{{ω}_{0}} = \frac{{P}_{0}}{2} ⌋\end{matrix}$$

In Expression 3, ω₀ is a basic frequency. The range of amplitude of m of X_{W}(m) is 0≦m≦N1. Additionally, l represents the number of harmonics. The error energy Eₗ(ω₀) is an accumulated sum of square of difference of an absolute value of an input signal spectrum X_{W}(m) and an absolute value of a synthesized signal spectrum X′_{W}(m, ω₀) from start point aₗ of the l-th harmonic band to end point bₗ of the harmonic band.

When the error energy is obtained by the Expression 3 (S203), a pitch basic frequency coo at which the error energy Eₗ(ω₀) is minimized is selected by repeating the step S202 and the step S203 on M fractional pitch candidates (S204). At this time, to minimize the error energy, Expression 3 can be partially differentiated

$$\frac{\partial {E}_{i}}{\partial {A}_{i}} = 0$$

in terms of Aₗ(ω₀). Expression 4 is as follows:

$$Expression 4 : \\ {A}_{i} = \frac{{\sum }_{m = {a}_{i}}^{{b}_{i}} \vert {X}_{W} ( m ) \vert \vert {W}_{R} [ \frac{N2}{N1} m - \frac{N2}{2 π} {ω}_{0} l + 0.5 ] \vert}{{\sum }_{m = {a}_{i}}^{{b}_{1}} \vert {W}_{R} [ \frac{N2}{N1} m - \frac{N2}{2 π} {ω}_{0} l + 0.5 ] {\vert}^{2}} .$$

To enhance reliability of the harmonic amplitude Aₗ(ω₀) represented by Expression 4, a precise fractional pitch should be first searched for in which the error energy, expressed in Expression 5 of an input signal spectrum and a synthesized signal spectrum, is minimized over the given entire frequency band.

$$Expression 5 : \\ E ( {ω}_{0} ) = {\sum }_{l = 1}^{L} {E}_{i} ( {ω}_{0} ) ; {ω}_{0} ( o ) \leq {ω}_{0} \leq {ω}_{0} ( M - 1 )$$

where M is the number of fractional pitch candidates to be searched (e.g., 10). After performing step 204, Expression 4 is applied to the found coo and the maximum harmonic amplitude Aₗ(ω′₀) is found (S205).

This first embodiment is a fractional pitch based harmonic analyzing method. In the first embodiment, MMSE over the harmonic band expressed by fixed aₗ and bₗ according to the pitch value is used and the precise fractional unit pitch is searched for. If the pitch searching precision of the encoder degenerates due to limitation of allocated bit or calculation amount, the error between harmonic center frequencies of the original signal spectrum and the synthesized signal spectrum increases as it goes to high frequency. Therefore, the correlation that the numerator of Expression 4 implies decreases so that the harmonic analysis performance is reduced greatly. The performance depends on the precision of the input signal pitch and precise pitch search requires a lot of calculations.

On the other hand, if harmonic estimation is not applied to the entire frequency band and is adaptively controlled for each harmonic band according to frequency bands so that the dependency on the input pitch is removed and the calculation method, namely delta (A) adjusting method, is used to reduce calculation amount for the pitch search. In this delta adjusting method, the corresponding harmonic frequency interval is adjusted left or right by Δ for each harmonic using integer unit pitch to calculate Δₗ at which the error energy of the input signal spectrum and the synthesized signal spectrum is minimized and the maximum harmonic amplitude is found using the Δₗ.

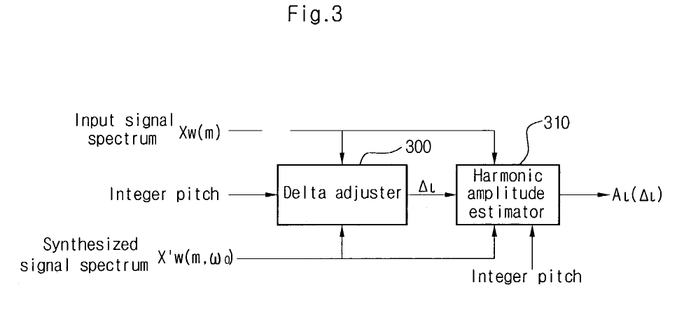

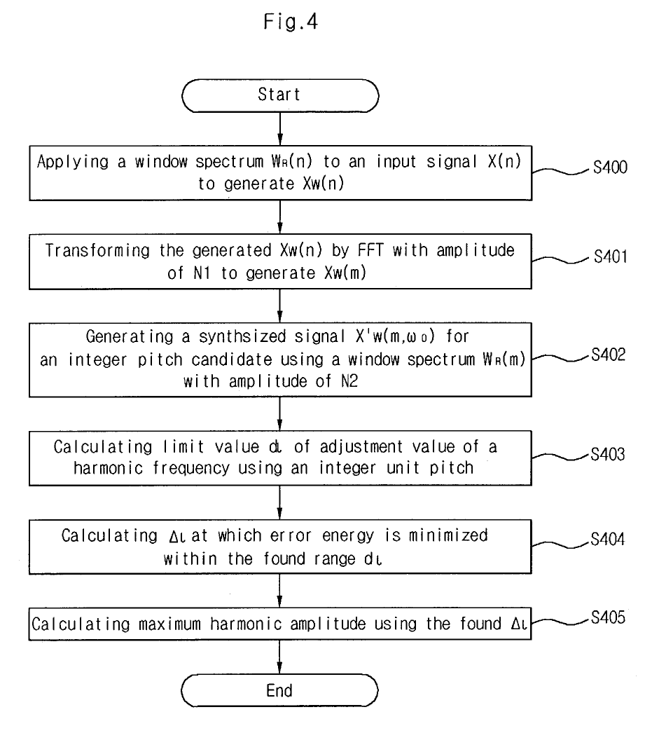

Referring to FIGS. 3 and 4, the delta adjusting method will be described. FIG. 3 is block diagram illustrating a harmonic estimating device using a delta adjusting method according to a second embodiment of the present invention. Referring to FIG. 3, the delta adjuster 300 calculates the range dₗ of the harmonic frequency adjustment value Δₗ using integer unit pitch and selects Δₗ at which Δₗ(Δ) is maximized as an optimal frequency adjustment value using Δₗ that belongs to the found range dₗ. The harmonic amplitude estimator 310 selects the value at which the harmonic amplitude is maximized as an optimal harmonic using the frequency adjustment value Δₗ that minimizes the error energy found by the delta adjuster 300.

FIG. 4 is a flowchart illustrating a harmonic estimating method using a delta adjusting method according to a second embodiment of the present invention. Referring to FIG. 4, a window spectrum W_{R}(n) is multiplied to an input signal x(n) and a new input signal x_{W}(n) is generated (S400). The generated input signal x_{W}(n) is transformed by FFT with amplitude of N1 and an input signal spectrum X_{W}(m) is generated (S401). The generated input signal spectrum X_{W}(m) is used as an input of the harmonic estimating device. The amplitude of m is greater than or equal to 0 and less than or equal to N1.

Then, after step S401, a synthesized signal spectrum X′_{W}(m, ω₀) for an integer pitch candidate is generated using the window spectrum W_{R}(m) with amplitude of N2 by Expression 1 (S402). The start point aₗ and the end point bₗ of l-th harmonic band of the synthesized signal spectrum X′_{W}(m, ω₀) are obtained using Expression 2. Then, after step S402, the limit value dₗ of harmonic frequency adjustment value Δₗ is found using integer unit pitch (S403). dₗ is found using Expression 6.

$$Expression 6 : \\ {d}_{i} = \frac{{α}_{2} - {α}_{1}}{L - 1} {ω}_{0} ( l - 1 ) + {α}_{2} {ω}_{0}$$

In Expression 6, dₗ represents the range of a harmonic frequency adjustment value Δₗ, and the value of dₗ is proportional to frequency and is small at low frequency band and large at high frequency band. Here, 0<α₁<α₂<1.0.

Then, after performing step S403, using Expression 7 in the found range dₗ, Δₗ is found at which the error energy Eₗ(Δ) is minimized in the range of the frequency adjustment value (S404). Expression 7 is as follows:

$$Expression 7 : \\ {E}_{i} ( {Δ}_{i} ) = {\sum }_{m = {a}_{i}}^{{b}_{i}} {\{ \vert {X}_{W} ( m + {Δ}_{i} ) \vert - \vert {X}_{W}^{′} ( m , {ω}_{0} ) \vert \}}^{2}$$

Expression 7 represents the summation of square of difference of an absolute value of X_{W}(m+Δ) and an absolute value of X′_{W}(m, ω₀) from the start point aₗ of the harmonic frequency band to the end point bₗ of the harmonic frequency band.

The range of Δₗ is from −dₗ to dₗ. Δₗ found in step 404 is applied to Expression 8 and the maximum harmonic amplitude is found (S405). Expression 8 is as follows:

$$Expression 8 : \\ {A}_{i} = \frac{{\sum }_{m = {a}_{i}}^{{b}_{i}} \vert {X}_{W} ( m + {Δ}_{i} ) \vert \vert {W}_{R} [ \frac{N2}{N1} m - \frac{N2}{2 π} {ω}_{0} l + 0.5 ] \vert}{{\sum }_{m = {a}_{i}}^{{b}_{i}} \vert {W}_{R} [ \frac{N2}{N1} m - \frac{N2}{2 π} {ω}_{0} l + 0.5 ] {\vert}^{2}}$$

The harmonic amplitude estimator 310 of the second embodiment selects the value at which the harmonic amplitude is maximized as an optimal harmonic using the frequency adjustment value that minimizes the error energy found by the delta adjuster 300 by squaring the difference of absolute value of the input signal spectrum and absolute value of the synthesized signal spectrum. Here, the harmonic amplitude Δₗ(ω₀) founded by expression 8.

In the harmonic estimation by the delta adjusting method, integer pitch is used to adjust harmonic interval and harmonic amplitude is found at which error energy is minimized so that harmonic estimation error generated in a high frequency band can be reduced. However, the harmonic estimation error can be generated due to pitch variation or the like.

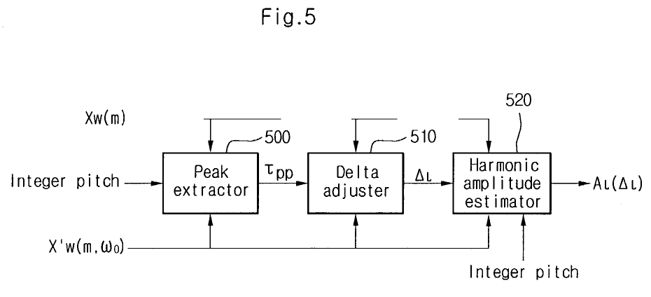

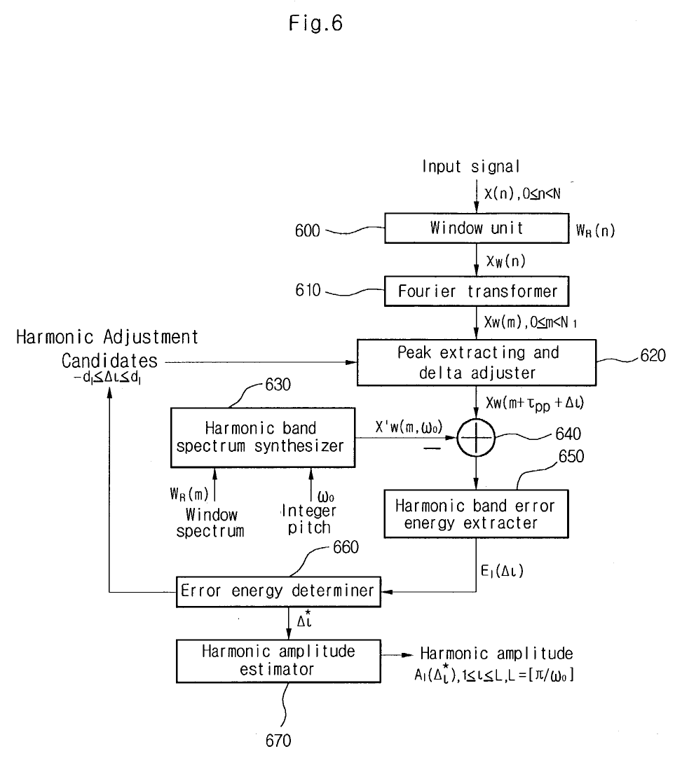

To resolve this problem, a harmonic estimating method is provided in which delta adjustment and peak peaking are used. In the other words, each harmonic peak is determined as a representative value of the harmonic and the harmonic is estimated. Over the entire frequency band, the harmonic peak of the original signal spectrum and the harmonic peak of the synthesized signal spectrum are made to coincide with each other using the above-mentioned method and the correlation of the numerator of Expression 4 is set to be large so that the harmonic amplitude is estimated finally using delta adjustment in the high frequency band. This will be described referring to FIGS. 5 and 6.

FIG. 5 is a schematic view illustrating a harmonic estimating device using a delta adjusting method and peak extracting according to a third embodiment of the present invention. Referring to FIG. 5, the harmonic estimating device using the delta adjustment and peak extracting includes a peak extractor 500, a delta adjuster 510 and a harmonic amplitude estimator 520. An input signal spectrum X_{W}(m) is generated by applying window spectrum W_{R}(n) to input voice signal x(n) and performing FFT with amplitude of N1. A synthesized signal spectrum X′_{W}(m, ω₀) is generated by applying window spectrum W_{R}(m) to an integer pitch candidate and performing FFT with amplitude of N2.

The peak extractor 500 extracts peak value from the entire band. In other words, the peak extractor 500 divides the entire band into one harmonic and calculates the highest value as a representative value of each harmonic. The extracted peak coincides at each harmonic of the original spectrum and the synthesized spectrum over the entire frequency band. In other words, the peak τpp that coincides with the harmonic peak is determined to be positioned at a maximum value of the original signal spectrum X_{W}(m) within the range of ±(1/2) ω₀ of ω₀×l corresponding to each harmonic peak position in the synthesized signal spectrum.

The delta adjuster 510 calculates the range dₗ of harmonic frequency adjustment value Δₗ using the highest value within entire band, and selects Δₗ at which Aₗ(Δ) is maximized as an optimal frequency adjustment value using Δₗ that belongs to the range dₗ. The limitation value of such a harmonic frequency adjustment is found as follows:

$$\frac{variation amount of adjustment range according to a band}{number of harmonic waves - 1} \times basic frequency ( 1 - th harmonic - 1 ) .$$

The harmonic amplitude estimator 520 selects the value at which the harmonic amplitude is maximized as an optimal harmonic using the frequency adjustment value Δₗ at which the error energy found by the delta adjuster 510 is minimized.

FIG. 6 is detailed view illustrating a harmonic estimating device using a delta adjusting method and a peak extracting according to a third embodiment of the present invention. Referring to FIG. 6, the harmonic estimating device using delta adjustment and peak extracting includes a window unit 600, a Fourier transformer 610, a peak extracting and delta adjuster 620, a harmonic band spectrum synthesizer 630, a synthesizer 640, a harmonic band error energy extractor 650, an error energy determiner 660 and a harmonic amplitude estimator 670.

A window unit 600 applies a window spectrum W_{R}(n) to an input voice signal x(n) and generates x_{W}(n). The Fourier transformer 610 performs FFT with amplitude of N1 on x_{W}(n) generated by the window unit 600 and generates input signal spectrum X_{W}(m). The peak extracting and delta adjuster 620 extracts a peak pp of harmonic and calculates the range dₗ of harmonic frequency adjustment value Δₗ using an integer unit pitch. The harmonic band spectrum synthesizer 630 applies the window spectrum W_{R}(m) to an integer pitch candidate ω₀ and generates a synthesized signal spectrum X′_{W}(m, ω₀) with amplitude of N2.

The synthesizer 640 subtracts the output of the harmonic spectrum synthesizer 630 from the output of the peak extracting and delta adjuster 620 and outputs the subtraction result. In other words, the result calculated from X_{W}(m+τpp+Δₗ)−X′_{W}(m, ω₀) is outputted. The harmonic band error energy extractor 650 calculates the error energy using the range dₗ of the harmonic frequency adjustment value Δₗ that is received from the synthesizer 640 and found by the peak extracting and delta adjuster 620.

The error energy determiner 660 determines whether the error energy at Δ*ₗ found by the harmonic band error energy extractor 650 is minimum. If the found error energy at Δ*ₗ is minimum as a determination result of the error energy determiner 660, the error energy minimum information is transferred to a harmonic amplitude estimator 670. The error energy minimum information can be Δ*ₗ at which error energy is minimizes.

If the found error energy at Δ*ₗ is not minimum as a determination result of the error energy determiner 660, the error energy determiner 660 extracts at least one candidate within the range of the found harmonic frequency adjustment Δₗ. Next, the error energy determiner 660 transfers the extracted candidate to the peak extracting and delta adjuster 620. Then, the input signal spectrum adjusted by the peak extracting and delta adjuster 620 is transferred as the error energy due to another candidate to the harmonic band error energy extractor 650 via the synthesizer 640. The error energy determiner 660 determines whether transferred Δₗ minimizes the error energy. The harmonic amplitude estimator 670 receives the minimum error energy at Δ*ₗ from the error energy determiner 660 and calculates the final harmonic amplitude Aₗ(Δ*ₗ) using the found dₗ and peak τpp. Here, 1≦l≦L, L=└nπ/ω₀┘.

In other words, each harmonic peak is determined to be the representative of the harmonic and the peak is made to coincide with each harmonic peak of an original signal spectrum and a synthesized signal spectrum over entire frequency band so that the correlation of the numerator of Expression 4 is large. Therefore, the harmonic amplitude is estimated finally using delta adjustment in the high frequency band.

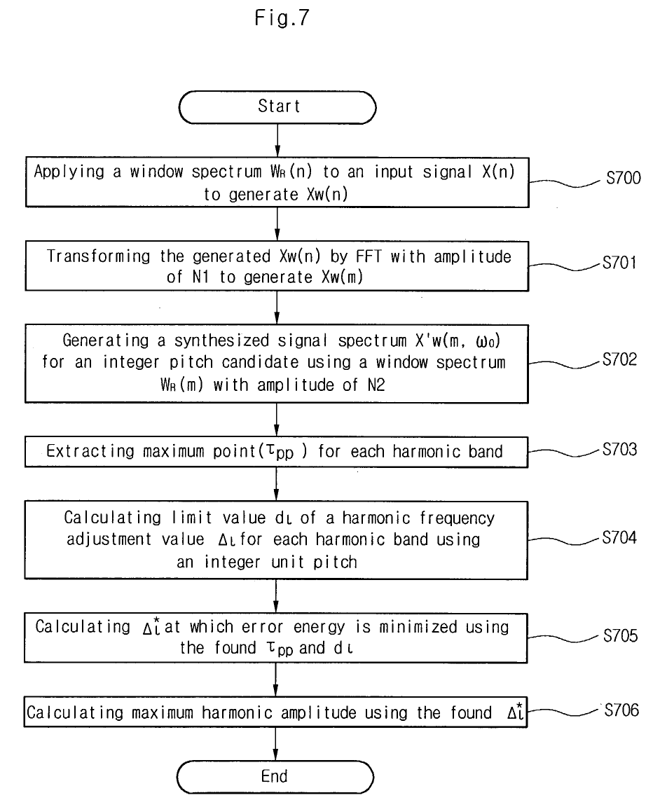

FIG. 7 is a flowchart illustrating a harmonic estimating method using a delta adjusting method and a peak extracting method according to a third embodiment of the present invention. Referring to FIG. 7, the window spectrum W_{R}(n) is applied to the input signal x(n) and x_{W}(n) is generated (S700). The generated x_{W}(n) is transformed by FFT with amplitude of N1 and the input signal spectrum X_{W}(m) is generated (S701). The generated input signal spectrum X_{W}(m) is used as an input of the harmonic estimating device. The amplitude of m is greater than or equal to 0 and less than or equal to N1.

After step S701, a synthesized signal spectrum X′_{W}(m, ω₀) for an integer pitch candidate is generated using the window spectrum W_{R}(m) with amplitude of N2 as Expression 1 (S702). The start point aₗ and the end point bₗ of l-th harmonic band of the synthesized signal spectrum are found using Expression 2. After step S702, each of the maximum values (peak =τpp) in the entire harmonic band is extracted (S703). The extracted maximum value can be τpp.

After step S703, the limit value dₗ of a harmonic frequency adjustment value Δₗ of each harmonic band using an integer unit pitch as Expression 9 (S704).

$$Expression 9 : \\ {d}_{l} = \frac{α}{L - 1} {ω}_{0} ( l - 1 )$$

where dₗ is the range of a harmonic frequency adjustment value Δₗ and the range is from −dₗ to dₗ, the value of dₗ is proportional to the frequency and is small at low frequency band and large at high frequency band, and α is a constant representing variation of adjustment range according to a band and less than or equal to 0.5.

After step S704, harmonic frequency is adjusted using the range dₗ of the found harmonic frequency adjustment value and peak τpp and the harmonic frequency adjustment value Δₗ at which the error energy represented by Expression 10 is minimized is found.

$$Expression 10 : \\ {E}_{l} ( {Δ}_{l} ) = {\sum }_{m = {a}_{l}}^{{b}_{l}} {\{ \vert {X}_{W} ( m + {Δ}_{l} + τ pp ) \vert - \vert {X}_{W}^{′} ( m , {ω}_{0} ) \vert \}}^{2}$$

Expression 10 represents the summation of square of difference of an absolute value of X_{W}(m+Δ) and an absolute value of X′_{W}(m, ω₀) which are affected by the harmonic frequency adjustment value from the start point aₗ of the harmonic frequency band to the end point bₗ of the harmonic frequency band.

The minimum dₗ found using Expression 9 at the step S705 and the harmonic adjustment Δ*ₗ found using Expression 10 are applied to Expression 11 and the final harmonic amplitude is found (S706).

$$Expression 11 : \\ {A}_{l} = \frac{{\sum }_{m = {a}_{l}}^{{b}_{l}} \vert {X}_{W} ( m + {Δ}_{l} + τ pp ) \vert \vert {W}_{R} [ \frac{N2}{N1} m - \frac{N2}{2 π} {ω}_{0} l + 0.5 ] \vert}{{\sum }_{m = {a}_{l}}^{{b}_{l}} {\vert {W}_{R} [ \frac{N2}{N1} m - \frac{N2}{2 π} {ω}_{0} l + 0.5 ] \vert}^{2}}$$

$$where - {d}_{l} \leq Δ \leq {d}_{l} , {d}_{l} = \frac{{αω}_{0}}{L - 1} ( l - 1 )$$

In Expression 11, the constant α representing variation of adjustment range according to a band is less than or equal to 0.5 and determined experimentally.

The peak τpp is determined to be positioned at maximum value of the original signal spectrum in the range ±(1/2) ω₀ of ω₀×l corresponding to each harmonic peak position in the synthesized signal spectrum and Δ*ₗ is found at which the error energy is minimized with respect to the value. As represented by Expression 11, the final harmonic amplitude Aₗ can be found more precisely by adding a delta value to an input signal spectrum and extracting a peak further to tune this value.

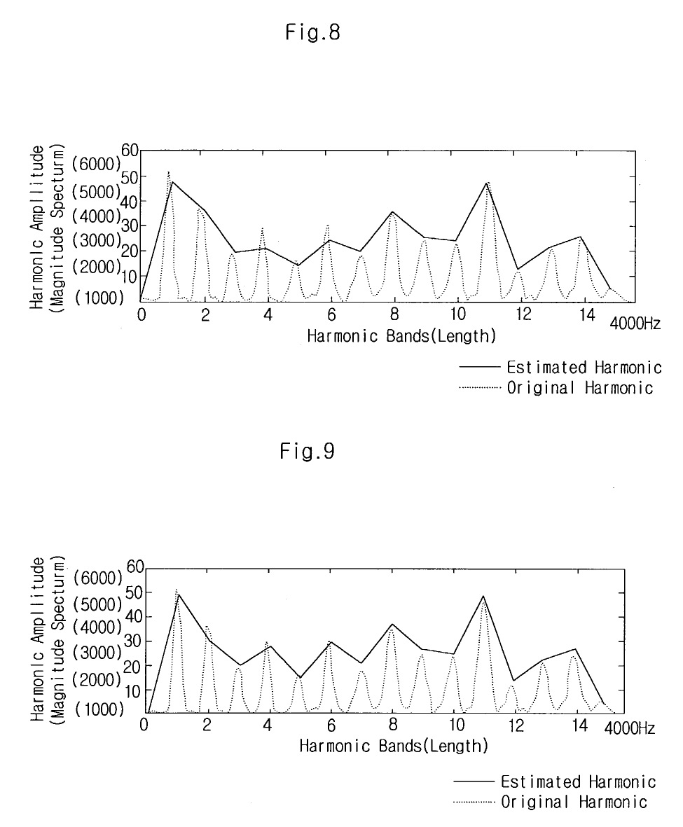

FIG. 8 illustrates a synthesized signal spectrum in the case using only a delta adjusting method. FIG. 9 illustrates a synthesized signal spectrum in the case using a delta adjusting method and a peak extracting method according to a third embodiment of the present invention. The error range in the case using a delta adjusting method and a peak extracting method is smaller than that in the case using only a delta adjusting method.

As described above, according to the present invention, devices and methods are provided for estimating harmonics in a voice encoder that reduce calculation amount using a peak extracting and a delta adjustment technology. The devices and methods for estimating harmonics in a voice encoder are very efficient in real time implementation in which a digital signal processor (DSP) is used and the calculation amount of the DSP is important. The devices and methods according to the present invention, for estimating harmonics in a voice encoder can substitute for the conventional technology by providing the technology for a low transmission rate voice encoder.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A harmonic estimating method comprising:
applying a window spectrum to an input signal, performing fast Fourier transformation of a predetermined amplitude on a generated spectrum, and calculating an input signal spectrum;
generating a synthesized signal spectrum of a fractional pitch candidate using the window spectrum scaled by a first basic frequency, harmonic amplitude, and high frequency signal amplitude;
calculating error energy of the input signal spectrum and the synthesized signal spectrum on each frequency band, and calculating a second basic frequency at which the error energy is minimized; and
calculating maximum harmonic amplitude at the second basic frequency.

2. The method according to claim 1, wherein the second basic frequency at which the error energy is minimized is selected by repeating the step of calculating the input signal spectrum and the synthesized signal spectrum of M fractional pitch candidates.

3. A harmonic estimating method comprising:
applying a window spectrum to an input signal, performing fast Fourier transformation of amplitude of N1 on a generated spectrum, and calculating an input signal spectrum;
applying a window spectrum scaled by harmonic amplitude to an integer pitch candidate, performing fast Fourier transformation of amplitude of N2 on a generated spectrum, and calculating a synthesized signal spectrum;
calculating an adjustment value of a high frequency at which error energy of the input signal spectrum and the synthesized signal spectrum for each band is minimized in range of the adjustment value of a harmonic frequency using the integer pitch candidate; and
calculating maximum harmonic amplitude by using the adjustment value of the high frequency at which the error energy for each band is minimized.

4. The method according to claim 3, wherein the adjustment value of the high frequency at which the error energy for each band is minimized is selected by squaring difference between an absolute value of the input signal spectrum and an absolute value of the synthesized signal spectrum, accumulating the squared difference from a start point of the band to an end point of the band, and selecting the adjustment value of the high frequency at which the error energy is minimized in range of a limit value of the adjustment value of the high frequency among the accumulated value.

5. The method according to claim 3, wherein the harmonic amplitude is estimated by:
if the input signal spectrum and the synthesized signal spectrum are found, calculating a maximum point in each harmonic band and a limit value of the harmonic frequency adjustment value;
calculating error energy for each band of the found input signal spectrum and the synthesized signal spectrum;
calculating a found harmonic frequency adjustment value and a found maximum point at which the error energy is minimized; and
calculating a final harmonic amplitude by using the found harmonic frequency adjustment value and the found maximum point.

6. The method according to claim 5, wherein the error energy is found by squaring a difference between an absolute value of the input signal spectrum and an absolute value of the synthesized signal spectrum and accumulating the squared differences for all harmonic bands.

7. The method according to claim 5, wherein the limit value of the harmonic frequency adjustment value is found by:
$$\frac{\begin{matrix}variation amount of adjustment \\ range according to a band\end{matrix}}{number of harmonic waves - 1} \times basic frequency ( 1 - th harmonic - 1 ) .$$

8. A harmonic estimating device comprising:
a harmonic frequency adjusting means for calculating a range of a harmonic frequency adjustment value using an integer unit pitch, and for selecting a frequency adjustment value at which error energy is minimized by using the harmonic frequency adjustment value belonging to the range; and
a harmonic amplitude estimating means for estimating a maximum harmonic amplitude by harmonics using the harmonic frequency adjustment value at which the error energy is minimized, the harmonic frequency adjustment value being found by the harmonic frequency adjusting means.

9. The device according to claim 8, wherein the range of the harmonic frequency adjustment value is proportional to a frequency and the range is small at a low frequency band and large at a high frequency band.

10. The device according to claim 8, wherein the error energy is found by squaring a difference between an absolute value of an input signal spectrum and an absolute value of a synthesized signal spectrum that are affected by the harmonic frequency adjustment value, and accumulating the squared difference from a start point of the harmonic to an end point of the harmonic.

11. The device according to claim 8, wherein the harmonic amplitude is estimated using the harmonic frequency adjustment value at which the error energy is minimized and a peak that coincides in harmonics of an original spectrum and a synthesized spectrum over the entire frequency band.

12. The device according to claim 11, further comprising a peak extracting means for extracting the peak in the entire frequency band.

13. The device according to claim 8, wherein the harmonic frequency adjusting means for selecting a value at which the harmonic amplitude is maximized selects an optimal frequency adjustment value by using a value that belongs to a range of harmonic frequency adjustment value.

14. A harmonic estimating device comprising:
a means for calculating an input signal spectrum of an input signal, and applying window spectrum to an integer pitch candidate, and a synthesized signal spectrum;
a means for extracting a peak point from each harmonic band, and calculating a limit value of frequency adjustment of each harmonic band;
a means for calculating error energy of the input signal spectrum and the synthesized signal spectrum for each band by using the limit value of frequency adjustment and the peak point;
a means for calculating a harmonic frequency adjustment value at which the error energy is minimized; and
a means for calculating a harmonic amplitude using the harmonic frequency adjustment value and the peak point.

15. The device according to claim 14, wherein the means for calculating the error energy adjusts a harmonic interval if the harmonic frequency adjustment value is not an adjustment value at which the error energy is minimized.

16. A harmonic estimating method comprising:
generating an input signal spectrum;
generating a synthesized signal spectrum;
calculating an adjustment value within a range of adjustment values at which error energy of the input signal spectrum and the synthesized signal spectrum for each band is minimized; and
estimating a maximum harmonic amplitude for each band by using the adjustment value for each band.

17. The method according to claim 16, wherein the error energy is determined by squaring a difference between an absolute value of the input signal spectrum and an absolute value of the synthesized signal spectrum, and accumulating the squared difference from a start point of the band to an end point of the band.

18. The method according to claim 16, further comprising:
determining a peak point in each band;
determining the adjustment value at which the error energy is minimized using the peak point; and
calculating the maximum harmonic amplitude using the harmonic frequency adjustment value and the peak point.

19. The method according to claim 16, wherein the error energy is found by squaring a difference between an absolute value of the input signal spectrum and an absolute value of the synthesized signal spectrum and accumulating the squared differences for the entire band.

20. The method according to claim 16, wherein the range is determined as ± a limit value of the harmonic frequency adjustment value, wherein the limit value is found by:
$$\frac{\text{variation amount of adjustment range according to a band}}{\text{number of harmonic waves} - 1} \times \text{basic frequency} ( 1 \text{-} th harmonic - 1 ) .$$

21. The method according to claim 16, wherein the range for the harmonic adjustment value is proportional to frequency so that the range increases as frequency increases.

22. The method according to claim 16, further comprising:
changing the adjustment value to another value within the range if the adjustment value is not an adjustment value at which the error energy is minimized.

23. A harmonic estimating device comprising:
a harmonic frequency adjuster that calculates a range of harmonic frequency adjustment values, and that selects a harmonic frequency adjustment value within the range at which error energy is minimized for each band; and
a harmonic amplitude estimator that estimates a maximum harmonic amplitude for each band using the harmonic frequency adjustment value at which the error energy is minimized.

24. The device according to claim 23, wherein the range of the harmonic frequency adjustment value is proportional to a frequency and the range is small at a low frequency band and large at a high frequency band.

25. The device according to claim 23, wherein the error energy is found by squaring a difference between an absolute value of an input signal spectrum and an absolute value of a synthesized signal spectrum, and accumulating the squared difference from a start point of the band to an end point of the band.

26. The device according to claim 23, wherein the harmonic amplitude is estimated using the harmonic frequency adjustment value at which the error energy is minimized and a peak that coincides in harmonics of an original spectrum and a synthesized spectrum for each band.

27. The device according to claim 23, further comprising a peak extractor for extracting a peak value that coincides in harmonics of an original spectrum and a synthesized spectrum for each band.

28. The device according to claim 23, wherein the harmonic frequency adjuster selects a value at which the harmonic amplitude is maximized using an optimal frequency adjustment value within the range.

29. The method according to claim 23, wherein the harmonic frequency adjuster adjusts the adjustment value to another value within the range if the adjustment value is not an adjustment value at which the error energy is minimized.
